(19) United States
(12) Patent Application Publication
(10) Pub. No.: US 2003/0051510 A1
(43) Pub. Date: Mar. 20, 2003

(54) Device for melting and refining of highly pure optical glasses

(75) Inventors: Hildegard Romer, Karben (DE); Uwe Kolberg, Mainz (DE); Werner Kiefer, Mainz (DE); Ernst-Walter Schafer, Welgesheim (DE); Guido Rake, Rummelsheim (DE)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(73) Assignee: Schott Glas

(21) Appl. No.: 10/192,774

(22) Filed: Jul. 10, 2002

(30) Foreign Application Priority Data
Jul. 10, 2001 (DE) 101 33 469.9-45

(51) Int. Cl. C03B 5/00; F27B 14/00

(52) U.S. Cl. 65/347; 65/374.11; 65/374.12; 65/374.13; 432/156; 373/27

(57) ABSTRACT

A device for the melting of highly pure optical glasses and/or for the treatment of melts is provided. The device is intended for a subsequent refining or homogenization process making use of the skull technique. The device uses a number of coated metal tubes whose surface is free of glass-coloring ions.

### BACKGROUND OF INVENTION

1. Field of the Invention

This invention concerns the glassmaking process. More particularly this invention concerns the making and treating of glass melts.

2. Description of the Prior Art

The glassmaking process begins with the melting down of so-called batches or cullets. The melting process is followed by a refining process, which serves to drive out physically or chemically bound gases from the melt.

Extreme requirements concerning transmission, freedom from particles, and freedom from striations are being increasingly placed on optical glasses.

Usually, optical glasses are melted in crucibles made from platinum. In the case of certain aggressive glasses, there often occurs an erosion of Pt or PtOₓ. The PtOₓ results in a discoloration, especially in the UV and the blue spectral region. The dissolving of the Pt, or the reducing of PtOₓ to form Pt, results in contaminating Pt particles in the glass, which are especially unacceptable in glasses for laser applications.

Since the platinum is especially attacked and dissolved during the melting down of the batch, the meltdown process is preferably conducted in a melting tank made from refractory ceramic material. The ceramic melting tank usually adjoins a platinum refining chamber and a homogenization system made from Pt. Vitreous silica is preferably used as the ceramic refractory material for the melting tank. However, there are optical glasses, such as the lanthanum borate glasses or the fluorine-containing glasses which dissolve silicic acid so much that an economical production is not possible. Yet even in the case of somewhat less aggressive glasses, striations are formed by the dissolving of vitreous silica. And these striations are no longer fully dissolved in the course of the further melting process. These striations might not be acceptable in applications with extreme requirements on homogeneity, such as those for stepper lenses in chip manufacture.

Therefore, a number of patents describe the melting of highly pure glasses in an air or water-cooled quartz crucible (U.S. Pat. No. 3,997,313, GB Patent 1,404,313, EP 0109131). Although the air or water cooling reduces the erosion of SiO₂, it cannot prevent it. Within the crucible and during the course of the melting process, temperature fluctuations and thus corrosion of the crucible occur.

Other ceramic refractory materials like Al₂O₃, which would better withstand the glass corrosion, are generally rather heavily contaminated with transitional elements like Fe, so that they are not suitable for applications in which high transmission is required, such as glass optical fibers for lighting engineering.

Another device for melting of glass is skull melting. The principle is described, for example, in U.S. Pat. No. 4,049,384. This makes use of a crucible whose surrounding wall is formed of refrigerable metal tubes. During the melting process, a crust (skull) of species-specific material forms in the region of this wall, so that the metal tubes are covered with this on the side in contact with the melt. The skull melting technique is preferably used for melting of high-melting glasses or crystals for manufacture of refractory materials or for growing crystals such as ZrO₂. The high-melting starting material (batch) forms in the region of the wall a crust of sintered, species-specific material. The advantage of the skull melting technique is that the formation of striations is suppressed, since the glass is melted in the species-specific material.

The principle of the skull crucible is successfully employed both in the melting process and in the refining process. The skull crucible has been further developed in numerous ways. See, for example, DE 199 39 772 A1. Here, a so-called mushroom-skull crucible is described. This prevents corrosion of the refrigerated metal tubes above the melt. The liquid-cooled metal tubes are outwardly curved in the shape of a mushroom in the upper region. In the colder region, a ceramic ring is mounted on the cooled metal tubes. In this way, the metal tubes at the side facing the melt are completely covered with glass melt.

Investigations with such a mushroom-skull crucible have shown that although glass impurities are lessened, they cannot be completely avoided.

Thus, although melts which have been treated in skull crucibles—during melting or refining, for example—are free of striations, they often have colorations which greatly impair the quality of the glass and make the glass unusable for certain optical applications. Thus, for example, colorations occur in glass and may be more or less pronounced. Such colorations even occur when the refrigerated metal tubes of the skull crucible consist of certain special steels or copper, for example.

### SUMMARY OF THE INVENTION

The basic object of the invention is to provide a device with which highly pure optical glasses can be melted and/or refined. During the melting process or refining process, no metal particles, no coloring ions or foreign striations should be introduced into the glass melts. The glass quality should not be impaired either by metallic particles or by coloring ions or by striations. The quantity of coloring ions must be so low that it can only just be quantified by evaporation spectra on very long (≧10 m) glass optical fibers. The device according to the invention should also be suitable for glass melts of highly aggressive nature.

The above and other objects, advantages, and benefits of the present invention will be understood by reference to following detailed description and appended sheets of drawings.

### BRIEF DESCRIPTION OF THE DRAWINGS

Other and further objects, advantages and features of the present invention will be understood by reference to the following specification in conjunction with the accompanying drawings, in which like reference characters denote like elements of structure and:

FIG. 1, shows a mushroom-shaped skull crucible in front view. The mushroom-skull crucible A shown in FIG. 1 consists of a crown of water-cooled aluminum tubes, which in the upper part are outwardly bent by 90 degrees. A ring of refractory material is mounted on the outwardly bent tubes, and on this is placed the upper furnace lid D. The skull crucible is heated via the coil E with high frequency. In addition, the surface can also be heated with a burner F.

FIG. 2, shows a layout for melting, refining and homogenizing, in schematic representation. The batch loaded via a filling funnel is melted down in a mushroom-skull crucible A with water-cooled platinum tubes, since the heaviest attack of the tank material occurs during the meltdown. After the meltdown, the glass can be refined in a platinum gutter B, homogenized in a platinum agitator C, and conditioned in the platinum feeder D, with no fear of any substantial contamination from the inductively heated platinum.

FIG. 3, shows another layout for melting, refining and homogenizing in a schematic representation. The layout shown in FIG. 3 exhibits a mushroom-skull crucible A and a mushroom-skull crucible B with water-cooled, platinum-coated copper tubes, as well as a device C for homogenization and conditioning. In the case of highly aggressive glasses, it is advantageous to perform both the meltdown and the refining in a skull crucible. An intensified attack of the material occurs during the refining, as well as the meltdown, by reason of the high temperatures.

FIG. 4, shows a layout for melting and refining. In FIG. 4, one notices a mushroom-skull crucible A for melting of glass, and an additional mushroom-skull crucible B for refining, immediately adjoining it and located underneath. Both skull crucibles have water-cooled, platinum-coated special steel tubes. There is no horizontal connection piece here, unlike the embodiment of FIG. 3.

FIG. 5, shows a skull crucible of traditional design. It has water-cooled copper tubes. With this device, it was not possible to obtain the glasses in the desired purity. All of the glasses exhibited a slight color cast, due to the copper.

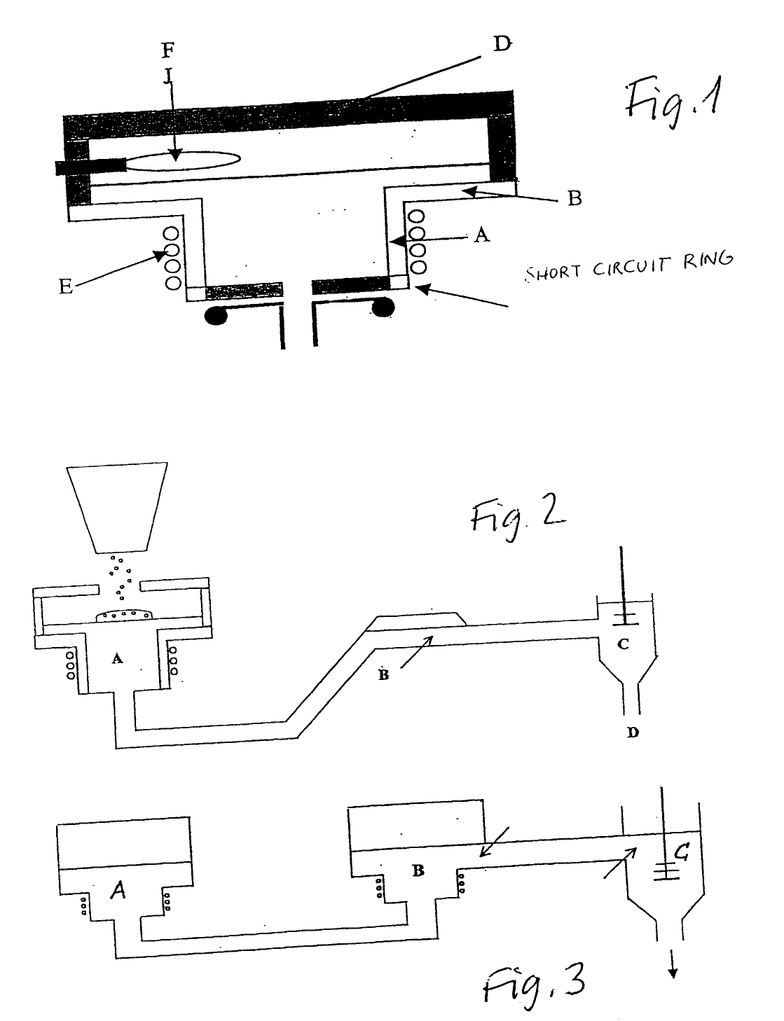

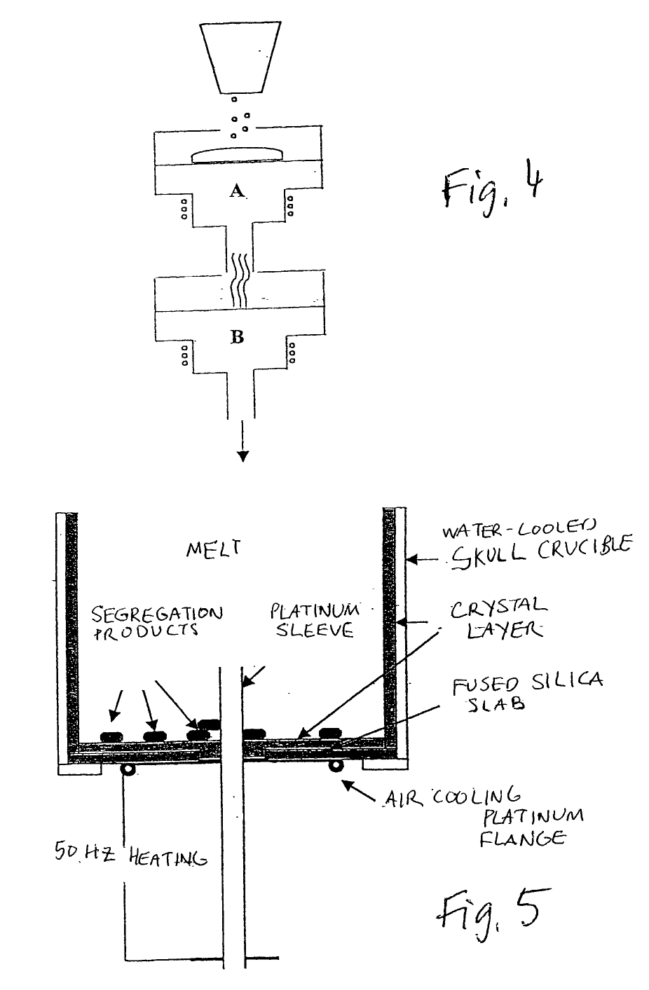

### DETAILED DESCRIPTION OF THE INVENTION

The inventors have discovered that, in the case of low-melting glasses, such as the usual optical glasses, during the skull melting process, rather than a thick skull layer of sintered species-specific material a thin glass layer will be present immediately next to the cooled metal tubes. Surprisingly, it has been found that an ion exchange occurs through this thin glass layer between the surface of the metal tubes and the hot glass melt. This is all the more surprising in that the metal tubes are cooled, for example, with water.

The invention is based on the fact that the material of the refrigerable tubes or at least their superficial layer is constituted such that either no ion exchange occurs between the refrigerable tubes and the melt, or the ions which diffuse through the thin glass layer into the molten glass do not adversely affect the glass composition. Although it was known that certain metals like platinum, iridium or rhodium have the property of coloring a glass melt, what is surprising is the mentioned discovery of ion exchange through the thin glass layer.

An ion exchange between the surface of the tubes and the molten glass can be suppressed when the surface of the tubes is present in metallic form, that is, when the surface of the tubes is not oxidized. In metallic form, the elements cannot participate in the ion exchange.

Experiments have revealed that, when using Pt tubes, no measurable Pt diffusion occurs through the glass layer. Virtually no oxidation of the noble Pt occurs at the water- cooled Pt tubes. Pt is a very noble metal and is resistant to both the oxygen of air and the oxygen from the molten glass. Besides Pt, Au is also resistant to oxygen attack. For reasons of stability and cost, however, the use of Au tubes is not sensible.

Although tubes made from Ir, Pd and Rh are relatively resistant to oxidation, the diffusion of smaller quantities into the molten glass cannot be ruled out. Since the ions of these elements color the glass, tubes made from these metals are not suitable for extreme requirements. If somewhat lower requirements are placed on the transmission, then these metals can also be used.

W, Mo and Nb are also resistant to oxidation at low temperatures. These metals have the drawback that they are difficult to process and their ions color the glass.

Furthermore, investigations have revealed that the ion exchange is also suppressed when only the surfaces of the tubes are coated with the noble metals. A surface finishing is on the one hand a cheaper possibility and on the other hand coated tubes of copper or special steel are more easily assembled into a skull crucible. It is also possible to coat the ready- assembled skull crucible.

Tubes of silver or tubes with a silver coating cannot be used straightaway. Silver even at room temperature has a tendency to easily form an oxide on the surface. Being a monovalent ion, Ag⁺ diffuses rather easily. Although Ag⁺ is colorless in molten glass, being a relatively noble metal it can be easily reduced to Ag⁰. Even if the Ag⁰ does not congregate into a large metal piece, the glass takes on a slight yellow coloration. Silver tubes or silver-coated tubes can therefore be used only in heavily oxidizing melts.

An ion exchange between the metal tube and the molten glass is permissible when the ion which migrates from the tube to the molten glass is a noncoloring ion which is incorporated into the glass lattice.

When using aluminum tubes, an ion diffusion of Al³⁺ into the molten glass cannot be ruled out, since the surface of aluminum metal is always coated with a thin oxide layer. Al³⁺ is a network-forming ion, which is entirely colorless. Experiments with a skull crucible made from aluminum tubes reveal no coloration of the glass melt or the molten glass. Neither can a formation of striations occur, since the quantity of Al³⁺ which diffuses from the tube into the glass melt is much too little to form a striation. Similar to aluminum tubes, other metal tubes without the glass-coloring ingredients can also be used, such as magnesium or zinc tubes. These metals can also diffuse as ions into the glass melt, without lowering the transmission of the glass.

Metal tubes such as copper or special steel tubes, for example, can also be coated with these metals, such as Al, Zn, Sn and Mg, since only the surface of the tubes comes into contact with the glass layer and through the glass layer with the melt. In the case of coated tubes, no troublesome diffusion within the metal tube has been found.

Another possibility is to provide the metal tubes with passivating layers. By passivating layers is meant here layers of metal oxides, metal nitrides, metal carbides, metal silicides or mixtures thereof. None of the metals which color glass melts should be used as metal ions in these compounds.

For example, possible metal oxide compounds for coating the metal tubes are Al ₂O₃, MgO, ZrO₂, Y₂O₃ and possibly the nitrides and carbides thereof.

For tungsten carbides or molybdenum silicides, the same holds as in the case of the metals, that is, under certain circumstances slight quantities can diffuse into the glass. In this case, the application will determine whether they can be used.

### EXAMPLE 1

An optical glass from the family of the lanthanum borate glasses (composition, see Table 1) was melted in a refined steel skull crucible coated with Pt. The following melt parameters were used:

Loading: 1240-1260° C.

Refining: 1280° C.

Quieting: 1240-1200° C.

Casting: approximately 1200° C. in the crucible; approximately 1100° C. in the feeder

The melt was cast into molds of various geometries (disks, rods, bars) and cooled down from 650° C. to room temperature.

The following values were measured:

| | |
|---|---|
| nd = 1.71554; | (1.71300) |
| νd = 53.41; | (53.83) |
| ΔPg, F = 0.0084; | (−0.0083) |
| τi (400 nm; 25 mm) = 0.972; | (0.94) |

The reference values given in parentheses were measured on a glass of the same composition that was melted with the traditional technology, that is, in an inductively heated Pt crucible.

The improvement can be seen in that the pure transmission in the blue spectral region has decisively increased. Absorption in the blue cause a yellowish hue, so that the smallest possible absorption is desirable for observational applications such as photography, microscopy and telescopes. The deviations in the coefficient of diffraction and the Abbe number are due to the somewhat higher evaporation rates of the new technology and can easily be corrected by fine tuning of the batch.

Another experiment with the same glass under comparable melting conditions produced the following values:

| | |
|---|---|
| nd = 1.70712; | (1.71300) |
| νd = 53.68; | (53.83) |
| ΔPg, F = −0.0084; | (−0.0084) |
| τi (400 nm; 25 mm) = 0.965; | (0.94) |
| τi (365 nm; 255 mm) = 0.831; | (0.72) |

Here, the characteristic value of the transmission at 365 nm, which is characteristic of many UV applications, has also been determined. This wavelength corresponds to an important emission line of mercury vapor lamps, which is used for many applications. The light efficiency at this wavelength can be boosted by 0.111 or 15% when using the new technology, which corresponds to a definite product advantage. Furthermore, one notices the possibilities of the above-mentioned corrective measures from the deviation of the refractive index toward lower values.

### EXAMPLE 2

This involves a glass from the family of the alkaline zinc silicate glasses. It is used for the production of fibers for light engineering (optical waveguides). Here, a good transmission and a slight color cast is of definite significance. Therefore, Pt contact during the melting should be avoided as much as possible.

Thus far, a solution has been found by melting in silica glass crucibles. But due to the high content of ZnO (>30%) and R₂O (>10%; R=Na, K), these glasses are distinctly aggressive to silica glass. A normal silica glass crucible with a wall thickness of 4-5 mm often becomes so thin already after one day of production that no further usage is possible. In 10-20% of all cases, the crucible is broken, so that the melt was unusable.

For this family of glass, it was possible to successively employ a skull crucible made of aluminum. Just like the crucible made from Pt-coated special steel, it exhibited a theoretically unlimited lifetime. No discoloring impurities occurred. No erosion of aluminum with aluminum getting into the glass was found. Furthermore, slight quantities of Al₂O₃ up to 0.5% do not influence the desired glass properties, as long as highly pure material is used. The following melt parameters were used:

Loading: 1300° C.

Refining: 1450° C.

Quieting: 1350° C.

Casting: approximately 1250° C. in the crucible; approximately 1200° C. in the feeder

The following characteristic pure transmission values were determined (again, in parentheses, the values for the same glass are given, yet melted with conventional melting techniques in an inductively heated Pt crucible):

τi (300 nm; 25 mm)=0.0010 (0.0011)

τi (330 nm; 25 mm)=0.6263 (0.5565)

τi (350 nm; 25 mm)=0.9680 (0.8959)

τi (370 nm; 25 mm)=0.9951 (0.9600)

τi (400 nm; 25 mm)=0.9995 (0.9839)

τi (420 nm; 25 mm)=0.9972 (0.9890)

τi (450 nm; 25 mm)=0.9985 (0.9924)

At 300 nm, we are in the region where the glass itself is absorbing. No differences in the pure transmission are evident here. At all higher wavelengths, one clearly recognizes the influence of Pt, which forces down the pure transmission values of the conventionally melted glass.

This becomes especially evident at the wavelengths 330 nm and 350 nm, but the influence can be demonstrated even into the visible region. One must also note that the pure transmission is normalized to a maximum value of 1, so that it is a poor measure of the achieved improvements in the vicinity of 1. A better measure here is the attenuation, expressed in dB/km. For 450 nm, one obtains 26 dB/km for the new melting device and 130 dB/km for the melt produced in a Pt crucible. The improvement is clearly recognizable here (smaller values are better here than large ones).

TABLE 1
Glass composition for Examples 1 and 2

| Oxide | Example 1 | Example 2 |
|---|---|---|
| B₂O₃ | 40 | — |
| CaO | 6 | — |
| La₂O₃ | 42 | — |
| SiO₂ | 2 | 45 |
| ZnO | 6 | 38 |
| ZrO₂ | 4 | — |
| Sb₂O₃ | 0.05 | — |
| Na₂O | — | 8 |
| K₂O | — | 9 |
| As₂O₃ | — | 0.3 |

For the glasses of Example 1, the components B₂O₃ and Ln₂O₃ (Ln=Sc, Y, La, Gd, Yb, Lu) are characteristic. They can be varied in a broad concentration range. All other components are optional and can be supplemented with additional ones. In this way, optical glasses of the families LaK, LaF, and LaSF can be produced in a broad range of refractive index and Abbe coefficient.

For the glasses of Example 2, the characteristic components are given in the table. Partial substitutions up to 10% can be conducted by the customary rules, i.e., for example, ZnO replaced by BaO, Na₂O replaced by Li₂O, SiO₂ replaced by Na₂O+Al₂O₃, and so on. In special cases, the extent of the substitution can even be greater.

Other modifications of the present invention will be obvious to those skilled in the art in the foregoing teachings. Moreover, while the present invention has been described with reference to specific embodiments and particular details thereof, it is not intended that these details be construed as limiting the scope of the invention, which is defined by the following claims.

The present invention having been thus described with particular reference to the preferred forms thereof, it will be obvious that various changes and modifications may be made therein without departing from the spirit and scope of the present invention as defined in the appended claims.

What is claimed is:

1. A device for the melting of highly pure optical glasses, which are free of metal particles, coloring oxides, and foreign striations, by means of the skull melting technique, characterized in that the metal tubes or the coatings of the metal tubes of the skull crucible consist of a nonoxidizing material or a material containing no ions coloring the glass melt.

2. The device according to claim 1, further characterized in that the metal tubes of the skull crucible consist of a nonoxidizing or very little oxidizing material such as platinum or a platinum alloy.

3. The device according to claim 1, further characterized in that the metal tubes of the skull crucible consist, for example, of copper or steel and their coating consists of a nonoxidizing or only very slightly oxidizing material such as platinum, gold, silver or their alloys.

4. The device according to claim 1, further characterized in that the metal tubes of the skull crucible consist of a material containing none of the ions which color the glass melt, such as aluminum, magnesium or zinc.

5. The device according to claim 1, characterized in that the metal tubes of the skull crucible consist, for example, of copper or steel, and their coating consists of a material which contains no ions coloring the melt, such as a metal coating of aluminum, magnesium, tin, zinc or their alloys.

6. The device according to claim 1, further characterized in that the metal tubes of the skull crucible consist, for example, of copper or steel and their coating consists of a metal oxide, such as Al₂O₃, MgO, ZrO₂, Y₂O₃ or their combination; or a metal nitride; or a metal carbide such as tungsten carbide; or a metal silicide such as molybdenum silicide or combinations thereof.

7. The device according to claims 1 to 6, further characterized in that the skull crucible is constructed in cylindrical form.

8. The device according to claims 1 to 7, further characterized in that the skull crucible is constructed in the form of a mushroom crucible.
